(19) United States
(12) Patent Application Publication
(10) Pub. No.: US 2026/0086488 A1
(43) Pub. Date: Mar. 26, 2026

(54) MEDIUM DISCHARGE SYSTEM AND IMAGE FORMING APPARATUS

(71) Applicant: FUJIFILM Business Innovation Corp., Tokyo (JP)

(72) Inventors: Suguru GOTO, Kanagawa (JP); Yuya CHONABAYASHI, Kanagawa (JP); Yasunobu GOTO, Kanagawa (JP); Satoshi WATANABE, Kanagawa (JP); Yuki KOHNO, Kanagawa (JP); Yoshinori KODAKARI, Kanagawa (JP); Yasuhisa FUKUDA, Kanagawa (JP); Yuki KAWAZOE, Kanagawa (JP)

(73) Assignee: FUJIFILM Business Innovation Corp., Tokyo (JP)

(21) Appl. No.: 19/043,066

(22) Filed: Jan. 31, 2025

(30) Foreign Application Priority Data
Sep. 24, 2024 (JP) 2024-165675

(51) Int. Cl. G03G 15/00

(52) U.S. Cl. CPC G03G 15/6552; G03G 15/5029; G03G 2215/00734

(57) ABSTRACT

A medium discharge system includes a sensor that outputs a medium-present signal in a case of being displaced by a medium to be transported and outputs a medium-absent signal in a case where the displacement is eliminated, a discharge roll pair that is disposed downstream of the sensor in a transport direction of the medium, sandwiches the medium, and discharges the medium to a discharge unit, a moving member that moves the discharge roll pair in a width direction, which is a direction intersecting the transport direction of the medium, and a processor, in which the processor is configured to control an operating period of the moving member based on a time point at which the sensor starts to output the medium-present signal and length information of the medium.

### CROSS-REFERENCE TO RELATED APPLICATIONS

This application is based on and claims priority under 35 USC 119 from Japanese Patent Application No. 2024-165675 filed Sep. 24, 2024.

### BACKGROUND

### (i) Technical Field

The present invention relates to a medium discharge system and an image forming apparatus.

### (ii) Related Art

JP2006-160401A discloses a recording medium discharge device that increases an offset amount without increasing a machine size and that improves paper alignment performance.

### SUMMARY

The present disclosure provides a medium discharge system that includes a sensor that outputs a signal in response to displacement caused by a medium, and that improves accuracy of sorting, compared to a configuration in which the sensor operates a moving member based on a medium-absent signal.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium discharge system including a sensor that outputs a medium-present signal in a case of being displaced by a medium to be transported and outputs a medium-absent signal in a case where the displacement is eliminated, a discharge roll pair that is disposed downstream of the sensor in a transport direction of the medium, sandwiches the medium, and discharges the medium to a discharge unit, a moving member that moves the discharge roll pair in a width direction, which is a direction intersecting the transport direction of the medium, and a processor, in which the processor is configured to control an operating period of the moving member based on a time point at which the sensor starts to output the medium-present signal and length information of the medium.

### BRIEF DESCRIPTION OF THE DRAWINGS

Exemplary embodiment(s) of the present invention will be described in detail based on the following figures, wherein:

FIG. 1 is a schematic configuration diagram illustrating an image forming apparatus according to an exemplary embodiment of the present disclosure;

FIG. 2 is a block diagram illustrating a hardware configuration of a processor according to the present exemplary embodiment;

FIG. 3 is a front view illustrating a medium discharge system according to the present exemplary embodiment;

FIG. 4 is a front view illustrating a state in which an actuator type sensor pushed up to a leading end of a sheet member P outputs an ON signal in the medium discharge system according to the present exemplary embodiment;

FIG. 5 is a front view illustrating a state in which the actuator type sensor in contact with a trailing end of the sheet member P continuously outputs an ON signal from the state in FIG. 4 in the medium discharge system according to the present exemplary embodiment;

FIG. 6 is a front view illustrating a state in which an arm of the actuator type sensor returns to a basic posture and outputs an OFF signal in the medium discharge system according to the present exemplary embodiment;

FIG. 7 is a plan view illustrating a state in which a sheet member in a state of being sandwiched between the discharge roll pair is positioned at a basic position or a sorting position; and

FIG. 8 is a flowchart illustrating sorting of a sheet member on which an image is fixed in a processor of the present exemplary embodiment.

### DETAILED DESCRIPTION

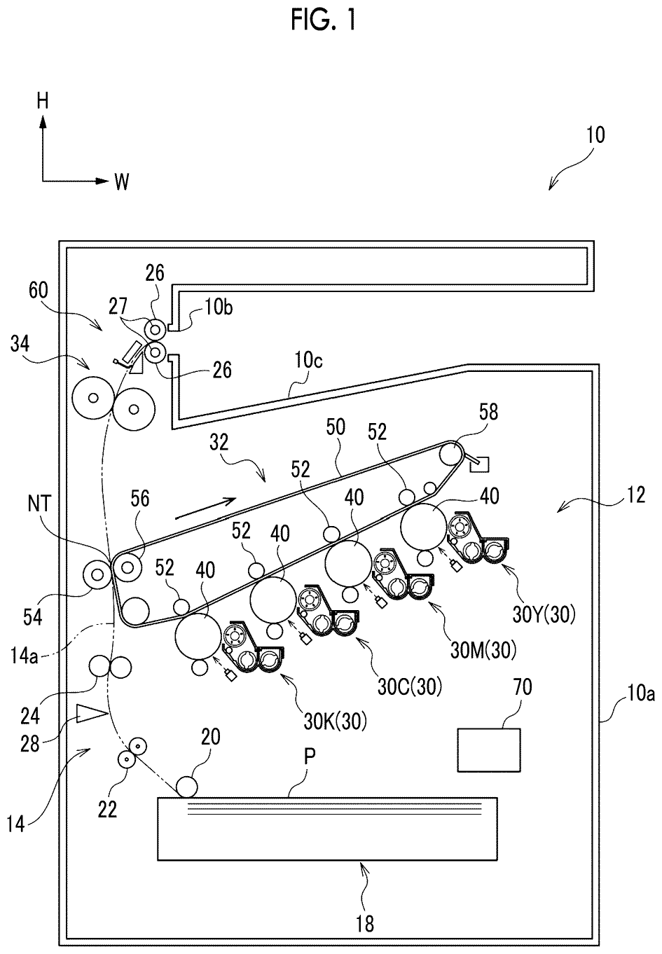

An example of an image forming apparatus according to an exemplary embodiment of the present disclosure will be described with reference to FIGS. 1 to 8. An arrow H illustrated in the drawing indicates an apparatus up-down direction (vertical direction), an arrow W indicates an apparatus width direction (horizontal direction), and an arrow D indicates an apparatus depth direction (horizontal direction).

### Overall Configuration of Image Forming Apparatus

As illustrated in FIG. 1, the image forming apparatus 10 forms an image on a sheet member P. The sheet member P is an example of a medium. The image forming apparatus 10 accommodates each component inside a box-shaped apparatus main body 10a. The image forming apparatus 10 includes an accommodation unit 18, a transporting unit 14, and an image forming unit 12. In addition, the image forming apparatus 10 includes a fixing unit 34, a sorting unit 60, and a controller 70. An opening portion 10b and a tray 10c are formed in the apparatus main body 10a. The opening portion 10b extends in the depth direction and is an opening from which a sheet member P after image formation is discharged from the inside of the apparatus main body 10a. The tray 10c is a part of the apparatus main body 10a having a plate surface on which the sheet member P discharged from the opening portion 10b is disposed. The tray 10c is an example of a discharge unit.

### Accommodation Unit

The accommodation unit 18 is formed in a box shape having an upper portion opened and is disposed in a lower part of the inside of the apparatus main body 10a. The accommodation unit 18 accommodates a plurality of sheet members P in a stacked state.

### Transporting Unit

The transporting unit 14 transports the sheet member P to each part in the apparatus main body 10a. In the present exemplary embodiment, the transporting unit 14 transports the sheet member P along a transporting path 14a extending in the up-down direction and the width direction in the apparatus main body 10a. The transporting unit 14 includes a feeding roll 20, a prevention roll pair 22, an adjustment roll pair 24, a discharge roll pair 26, a registration sensor 28, and a chute 64.

The feeding roll 20 is a cylinder along the depth direction and is disposed above the accommodation unit 18. The feeding roll 20 feeds the sheet member P accommodated in the accommodation unit 18 to the transporting path 14a.

The prevention roll pair 22 is a pair of cylinders along the depth direction and is disposed above the feeding roll 20 along the transporting path 14a. The prevention roll pair 22 prevents double feeding of the sheet member P fed by the feeding roll 20.

The adjustment roll pair 24 is a pair of cylinders along the depth direction and is disposed above the prevention roll pair 22 along the transporting path 14a. The adjustment roll pair 24 adjusts the timing at which the sheet member P is fed to the transporting path 14a (secondary transfer unit) on a downstream side of the adjustment roll pair 24.

The discharge roll pair 26 has a shaft 27 at the center thereof and is formed in a pair of cylinders along the depth direction. The discharge roll pair 26 is disposed above the adjustment roll pair 24 along the transporting path 14a. The discharge roll pair 26 faces the opening portion 10b of the apparatus main body 10a, and discharges the sheet member P to the tray 10c through the opening portion 10b, sandwiching the sheet member P. The discharge roll pair 26 is rotatably supported by the apparatus main body 10a. The discharge roll pair 26 is rotated around the depth direction by a drive unit (not illustrated) disposed at a depth direction end portion.

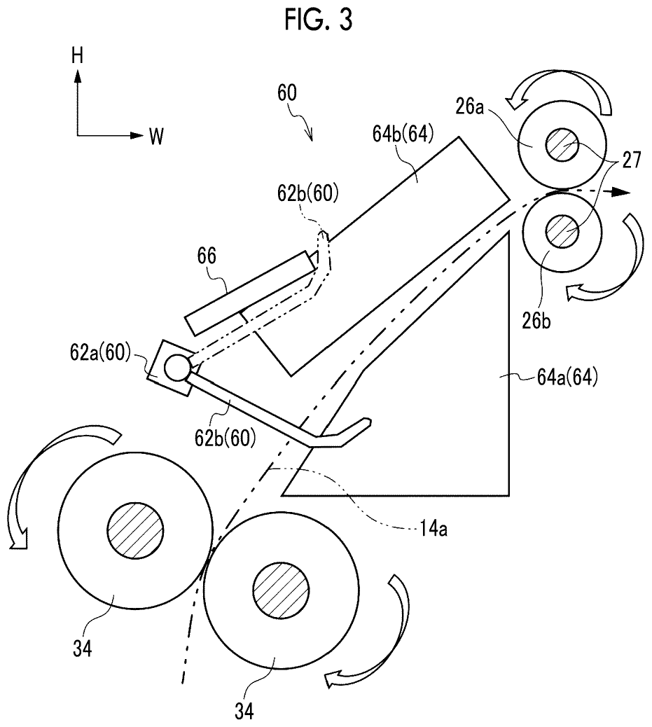

As illustrated in FIG. 3, the discharge roll pair 26 has an upper discharge roll 26a and a lower discharge roll 26b.

The upper discharge roll 26a is disposed above the transporting path 14a and rotates counterclockwise in a case where the sheet member P is discharged.

The lower discharge roll 26b is disposed below the transporting path 14a and rotates clockwise in association with the rotation of the upper discharge roll 26a in a case where the sheet member P is discharged. The lower discharge roll 26b is rotatably supported by the apparatus main body 10a in a state of being pushed against the upper discharge roll 26a from below. That is, in a case where the sheet member P is discharged from the opening portion 10b, the sheet member P is sandwiched between the upper discharge roll 26a and the lower discharge roll 26b.

As illustrated in FIG. 1, the registration sensor 28 is disposed upstream of the transporting path 14a of the prevention roll pair 22 and upstream of the transporting path 14a of the adjustment roll pair 24. The registration sensor 28 detects the presence or absence of the sheet member P in the transporting path 14a. The registration sensor 28 is an example of a measurement unit.

The chute 64 is formed in a plate shape extending in the depth direction and inclined with respect to the up-down direction. The chute 64 is disposed downstream of the fixing unit 34, which will be described later, and upstream of the discharge roll pair 26. The chute 64 constitutes a part of the transporting path 14a. The chute 64 has a lower chute 64a and an upper chute 64b.

The lower chute 64a guides the sheet member P from below. The upper chute 64b is disposed together with the lower chute 64a at a position sandwiching the transporting path 14a, and guides the sheet member P from above along the transporting path 14a. The lower chute 64a and the upper chute 64b are each formed with a plurality of ribs (not shown) arranged in the depth direction. The rib guides the sheet member P as a part of the transporting path 14a.

### Image Forming Unit 12

The image forming unit 12 forms a toner image on the sheet member P by means of an electrophotographic method. The image forming unit 12 is an example of a forming unit. In addition, the toner image is an example of an image. The image forming unit 12 is disposed above the accommodation unit 18. As illustrated in FIG. 1, the image forming unit 12 includes a toner image forming unit 30 and a transfer unit 32.

A plurality of the toner image forming units 30 are provided to form toner images for respective colors. In the present exemplary embodiment, in total, four colors of yellow (Y), magenta (M), cyan (C), and black (K) toner image forming units 30Y, 30M, 30C, and 30K are provided.

In the following description, in a case where it is not necessary to distinguish between yellow (Y), magenta (M), cyan (C), and black (K), Y, M, C, and K attached as the reference numerals are omitted.

The toner image forming unit 30 of each color is basically configured the same except for a toner to be used. The toner image forming unit 30 performs each of charging, exposure, and developing for each color.

The transfer unit 32 transfers the toner image formed by the toner image forming unit 30 onto the sheet member P. As illustrated in FIG. 1, the transfer unit 32 includes a transfer belt 50, a primary transfer roll 52, and a winding roll 56. Further, the transfer unit 32 includes a drive roll 58 and a secondary transfer roll 54.

The transfer belt 50 is a band that extends in the depth direction and is formed in an endless shape along the width direction and the up-down direction. The toner images of the respective colors are primarily transferred in a superimposed manner to the transfer belt 50 by the toner image forming unit 30.

The primary transfer roll 52 is a cylinder along the depth direction. The primary transfer rolls 52 are disposed on the opposite side of the toner image forming unit 30 with the transfer belt 50 interposed therebetween. The primary transfer roll 52 transfers the toner image formed by the toner image forming unit 30 to the transfer belt 50. In the present exemplary embodiment, four primary transfer rolls 52 are disposed according to the toner colors.

The winding roll 56 is a cylinder along the depth direction. The transfer belt 50 is wound around an outer periphery of the winding roll 56.

The drive roll 58 is a cylinder along the depth direction, and rotates around the depth direction by being driven by a drive unit (not illustrated). The transfer belt 50 is wound around the drive roll 58, and the drive roll 58 transmits a rotational force to the transfer belt 50. As a result, the transfer belt 50 circulates in an arrow direction in the drawing.

The secondary transfer roll 54 is disposed on the opposite side of the winding roll 56 with the transfer belt 50 sandwiched therebetween, and transfers the toner image transferred to the transfer belt 50 onto the sheet member P. A transfer nip NT for transferring the toner image onto the sheet member P is formed between the secondary transfer roll 54 and the transfer belt 50. The secondary transfer roll 54 is disposed downstream of the adjustment roll pair 24 in a transport direction. That is, the adjustment roll pair 24 feeds the sheet member P in conjunction with the transfer (secondary transfer) in the transfer nip NT.

In this configuration, the toner image is primarily transferred onto the transfer belt 50 by the primary transfer roll 52 in the order of yellow (Y), magenta (M), cyan (C), and black (K). In addition, the toner image is transferred from the transfer belt 50 by the secondary transfer roll 54 onto the sheet member P transported while being sandwiched between the transfer belt 50 and the secondary transfer roll 54.

### Fixing Unit

As illustrated in FIG. 1, the fixing unit 34 is a pair of cylinders along the depth direction and is disposed on a downstream side of the transfer nip NT in the transport direction of the sheet member P. The fixing unit 34 heats and presses the toner image transferred onto the sheet member P to fix the toner image to the sheet member P.

### Sorting Unit

The sorting unit 60 is disposed downstream of the fixing unit 34 in the transport direction of the sheet member P and upstream of the discharge roll pair 26 in the transport direction. The sorting unit 60 has a function of preparing for sorting the sheet members P. The sorting means discharging the sheet members P to positions different from each other in the depth direction. Further, preparing the sorting means acquiring information necessary for sorting by the discharge roll pair 26. The necessary information means that the trailing end of the sheet member P has passed through the fixing unit 34. The sorting unit 60 includes an actuator type sensor 62, a stopper 66, and a drive unit (not illustrated). The actuator type sensor 62 is an example of a sensor.

The actuator type sensor 62 detects a leading end of the sheet member P in the transport direction. The actuator type sensor 62 is disposed on the downstream side of the registration sensor 28 in the transport direction and is supported by the apparatus main body 10a. More specifically, the actuator type sensor 62 is disposed on the downstream side of the fixing unit 34 in the transport direction and is supported by the apparatus main body 10a.

In addition, the actuator type sensor 62 is disposed upstream of the discharge roll pair 26 in the transport direction of the sheet member P. In other words, the discharge roll pair 26 is disposed downstream of the actuator type sensor 62 in the transport direction of the sheet member P. The actuator type sensor 62 has a support portion 62a and an arm 62b.

The support portion 62a is supported by the apparatus main body 10a at a position away from the transporting path 14a. The support portion 62a is disposed at a position where the sheet member P transported from the fixing unit 34 does not come into contact with the support portion 62a.

The arm 62b has a rotary shaft (not illustrated) and is an elongated plate that is supported to be rotatable around the depth direction relative to the support portion 62a. The arm 62b is rotatable between a plurality of ribs in a portion of the chute 64 to which the sheet member P is transported.

As illustrated in FIG. 3, the arm 62b has a base end side supported by the support portion 62a so as to be rotatable and a leading end side is restricted from rotating clockwise by a restricting member (not illustrated) in a state of intersecting the transporting path 14a, and takes a basic posture. The leading end of the arm 62b is disposed between a plurality of ribs of the lower chute 64a in the basic posture.

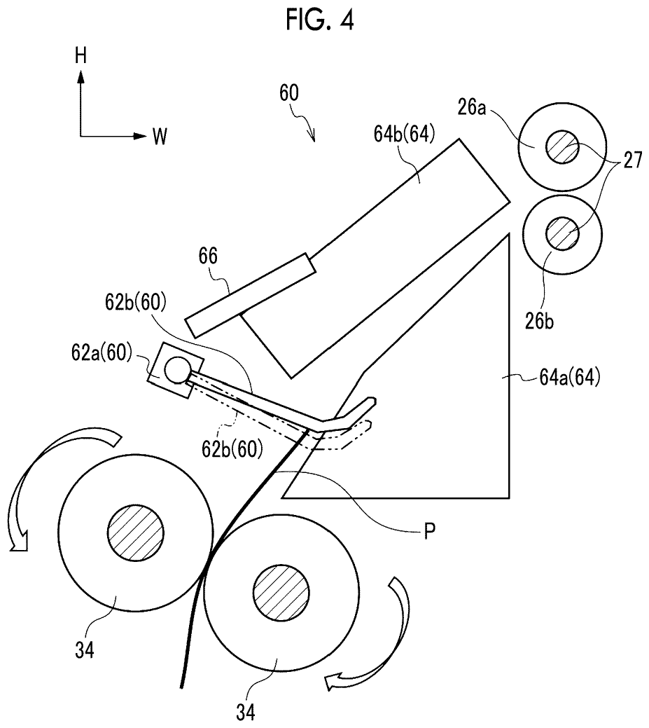

As illustrated in FIG. 4, in a case where the arm 62b is pushed up by an angle determined counterclockwise by the leading end of the sheet member P transported from the fixing unit 34, the arm 62b takes a start posture to start outputting an ON signal. That is, the actuator type sensor 62 is displaced by the transported sheet member P to output the ON signal. The ON signal is an example of a medium-present signal.

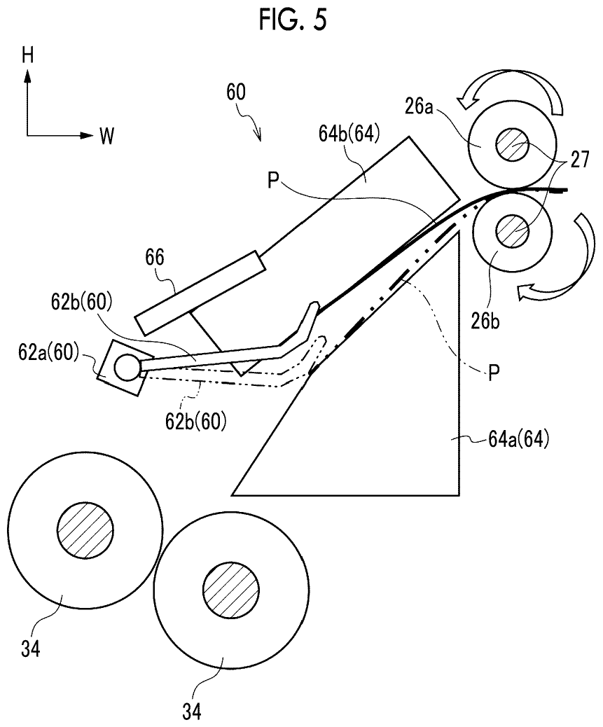

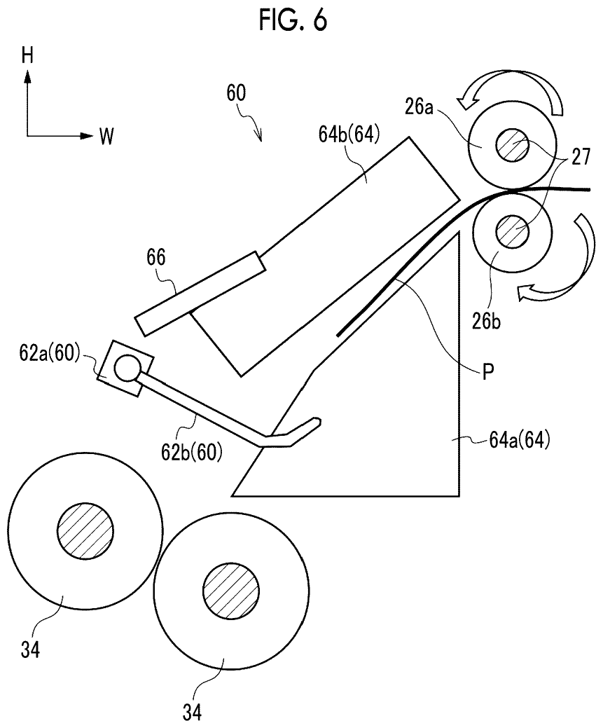

As illustrated in FIG. 5, in a case where the trailing end of the sheet member P passes, the arm 62b rotates clockwise by a restoring force of a torsion spring (not illustrated) and returns to the basic posture (refer to FIG. 6). The arm 62b outputs an OFF signal in a case where the arm 62b passes through the start posture during the process of returning to the basic posture. That is, the actuator type sensor 62 outputs the OFF signal in a case where the start posture is taken. The OFF signal is an example of a medium-absent signal. In FIG. 5, the sheet member P indicated by the solid line is transported to an upper chute 64b side. In addition, the sheet member P indicated by the two-dot chain line is transported to a lower chute 64a side.

The stopper 66 is plate-shaped and is disposed above the transporting path 14a and between a plurality of ribs of the upper chute 64b in the depth direction. The stopper 66 restricts a rotatable angular range of the arm 62b of the actuator type sensor 62 around the depth direction by coming into contact with the arm 62b.

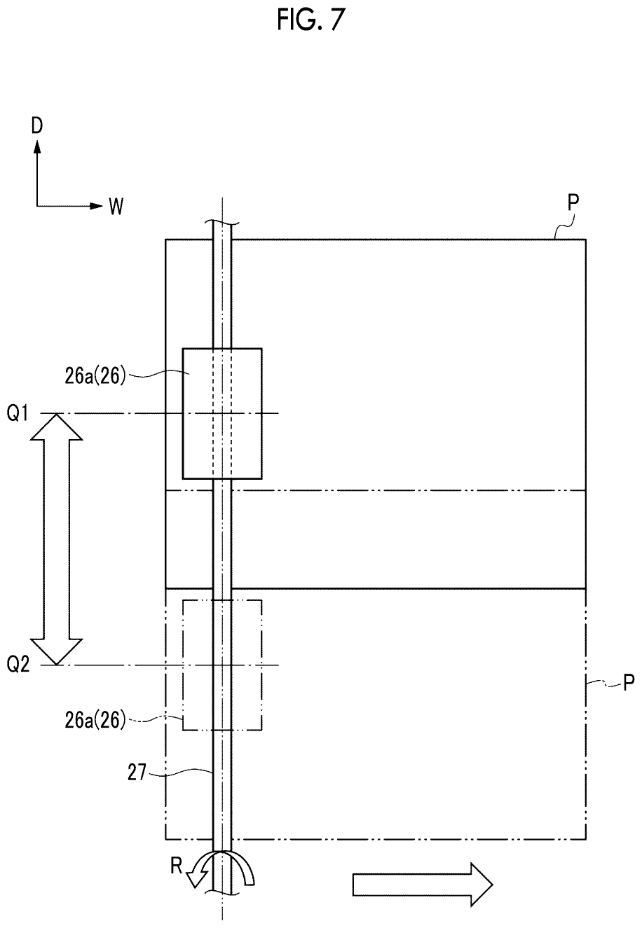

The drive unit moves the discharge roll pair 26 along the depth direction between the basic position Q1 and the sorting position Q2 located on the front side of the basic position Q1 along the depth direction (refer to FIG. 7). The drive unit is, for example, a geared motor. The drive unit is an example of a moving member. In addition, the depth direction is an example of a width direction of the medium.

### Controller

The controller 70 is disposed in the apparatus main body 10a and gives an instruction to each component of the image forming apparatus 10.

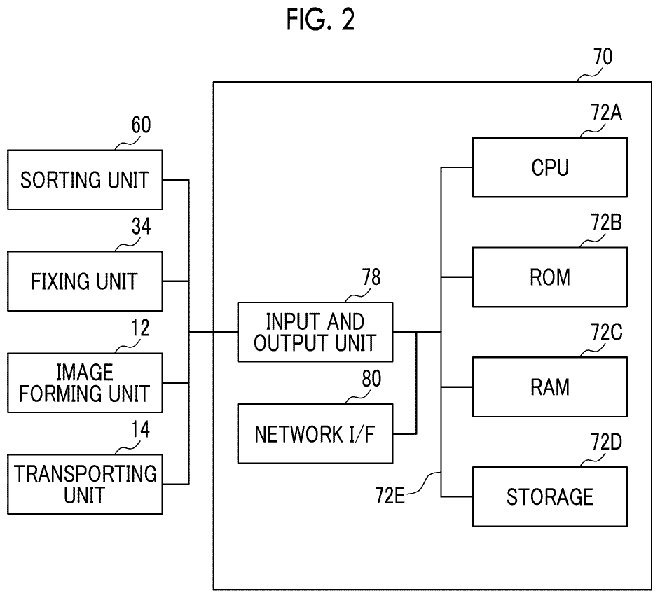

As illustrated in FIG. 2, the controller 70 includes each configuration of a central processing unit (CPU) 72A, a read only memory (ROM) 72B, a random access memory (RAM) 72C, a storage 72D, an input and output unit 78, and a network interface (network I/F) 80. These configurations are connected to be capable of communicating with each other via a bus 72E.

The CPU 72A is a central arithmetic processing unit that executes various programs and controls each unit. That is, the CPU 72A reads out a program from the ROM 72B or the storage 72D and executes the program using the RAM 72C as a work area. The CPU 72A controls each configuration described above and performs various arithmetic processes in accordance with the program recorded in the ROM 72B or the storage 72D.

The CPU 72A controls the operating period of the drive unit of the sorting unit 60 based on the time point at which the actuator type sensor 62 starts to output the ON signal and on the length information of the sheet member P in the transport direction. The operating period of the drive unit of the sorting unit 60 is a period including at least a start time and an end time of the movement of the discharge roll pair 26 in the depth direction. The CPU 72A is an example of a processor. In addition, a system configured with the CPU 72A, the actuator type sensor 62, the discharge roll pair 26, and the drive unit is an example of a medium discharge system.

The ROM 72B stores various programs and various types of data. The RAM 72C temporarily stores a program or data as the work area. The storage 72D is configured by a hard disk drive (HDD) or a solid state drive (SSD) and stores various programs including an operating system and various types of data.

The input and output unit 78 receives signals between each of the components of the image forming apparatus 10 in order to exhibit the function of the image forming apparatus 10.

A network I/F 80 is an interface for communicating with other devices such as a database and a server (both are not illustrated), and for example, standards such as Ethernet (registered trademark), FDDI, and Wi-Fi (registered trademark) are used.

### Major Configuration

Next, details of the sorting of the sheet members P on which the images formed by the image forming apparatus 10 are fixed will be described.

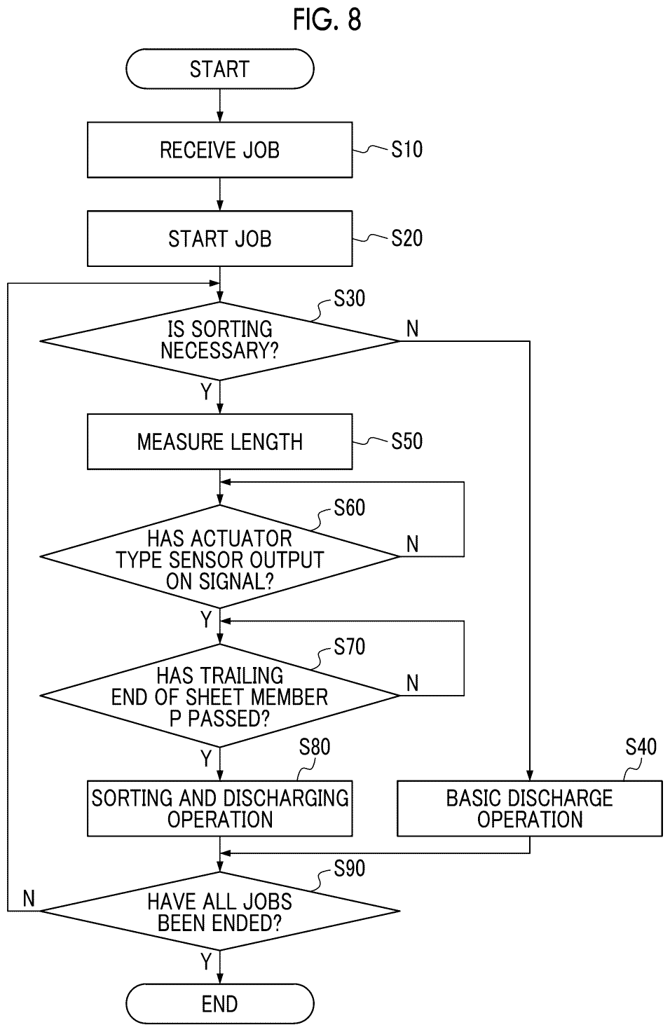

As illustrated in FIG. 8, the CPU 72A receives a job in Step S10. Then, the CPU 72A proceeds to Step S20.

The CPU 72A starts the job in Step S20. In the present exemplary embodiment, the sheet members P on which the images are formed are sorted. Then, the CPU 72A proceeds to Step S30.

The CPU 72A determines whether or not the sorting of the sheet members P is necessary based on the job data in Step S30.

### In Case Where Sorting Is Not Necessary

In a case where a determination result in Step S30 is “N” indicating a negative, the CPU 72A determines that the sorting of the sheet members P on which the images have been fixed is not necessary and proceeds to Step S40.

The CPU 72A executes a basic discharge operation in Step S40. As illustrated by a solid line in FIG. 7, the drive unit rotates the discharge roll pair 26 at a basic position Q1 in a R direction and discharges the sheet member P to the discharge roll pair 26 toward the tray 10c. Then, the CPU 72A proceeds to Step S90.

### In Case Where Sorting is Necessary

On the other hand, in a case where a determination result in Step S30 is “Y” indicating a positive, the CPU 72A determines that the sorting of the sheet members P on which the images have been fixed is necessary and proceeds to Step S50.

The CPU 72A starts measuring a length of the sheet member P in Step S50. Specifically, the CPU 72A acquires a timing at which the adjustment roll pair 24 feeds the sheet member P. In addition, the CPU 72A acquires a timing at which the OFF signal is output from the registration sensor 28. The CPU 72A measures a length of the sheet member P from the leading end to the trailing end in the transport direction based on these timings and a transport speed of the transporting unit 14. The measured length is an example of length information.

Then, the CPU 72a proceeds to Step S60.

The CPU 72A determines whether or not the actuator type sensor 62 has output the ON signal in Step S60.

In a case where the determination result is “N”, the CPU 72A determines that the sheet member P has not reached the actuator type sensor 62, and returns to Step S60.

On the other hand, in a case where the determination result is “Y”, the CPU 72A determines that the sheet member P has reached the actuator type sensor 62, and proceeds to Step S70.

The CPU 72A determines whether or not the trailing end of the sheet member P has passed through the fixing unit 34 in Step S70. Specifically, the CPU 72A determines whether or not a time required for the sheet member P to be transported by a length of the sheet member P measured in Step S50 has elapsed, from the detection of the ON signal output from the actuator type sensor 62.

In a case where the determination result is “N”, the CPU 72A determines that the trailing end of the sheet member P has not passed through the fixing unit 34 and that the preparation for sorting is not completed, and returns to Step S70.

On the other hand, in a case where the determination result is “Y”, the CPU 72A determines that the trailing end of the sheet member P has passed through the fixing unit 34 and that the preparation for sorting is completed, and proceeds to Step S80.

The CPU 72A executes the sorting and discharging operation in Step S80. In the sorting and discharging operation, as indicated by the two-dot chain line in FIG. 7, the drive unit rotates the discharge roll pair 26 in the R direction while moving the discharge roll pair 26 to the sorting position Q2 on the front side in the depth direction. Further, the drive unit discharges the sheet member P toward the tray 10c from the discharge roll pair 26.

In the present exemplary embodiment, the drive unit starts to operate after the trailing end of the sheet member P on which the image is fixed passes through the fixing unit 34 and before the actuator type sensor 62 outputs the OFF signal.

Then, the CPU 72a proceeds to Step S90.

### Determining End of Flow

In Step S90, the CPU 72A determines whether or not all the jobs have been ended.

In a case where the determination result is “N”, the CPU 72A determines that all the jobs are not ended, and returns to Step S30.

On the other hand, in a case where the determination result is “Y”, the CPU 72A ends the flow assuming that all the jobs have been ended.

As described above, the sheet members P on which the images are fixed by the image forming apparatus 10 are sorted.

### Operation and Effect

The medium discharge system of the present exemplary embodiment includes the actuator type sensor 62, the discharge roll pair 26, the drive unit, and the CPU 72A. More specifically, the medium discharge system of the present exemplary embodiment includes the actuator type sensor 62 that outputs an ON signal by being pushed up by a predetermined angle by the sheet member P to be transported and outputs an OFF signal in a case where a displacement of the pushed-up angle is eliminated, a discharge roll pair 26 that is disposed downstream of the actuator type sensor 62 in a transport direction of the sheet member P, sandwiches the sheet member P, and discharges the sheet member P to the tray 10c, the drive unit that moves the discharge roll pair 26 in a depth direction, which is an intersection direction of the transport direction of the sheet member P, and the CPU 72A, in which the CPU 72A controls the operating period of the drive unit based on a time point at which the actuator type sensor 62 starts to output the ON signal and on the length information of the sheet member P.

According to the configuration, in the medium discharge system having the sensor that outputs the signal in response to the displacement caused by the sheet member P, the accuracy of the sorting is improved as compared with a configuration in which the actuator type sensor 62 outputs the OFF signal by eliminating the displacement of the sheet member P.

In addition, the medium discharge system of the present exemplary embodiment further includes a registration sensor 28 that is disposed upstream of the actuator type sensor 62 in the transport direction of the sheet member P and measures the length of the sheet member P in the transport direction, and the CPU 72A obtains the length information from the registration sensor 28.

According to the configuration, the accuracy of sorting may be improved as compared with a configuration in which length information in the transport direction of the sheet member P is obtained from the job data determined according to the size of the sheet member P.

The image forming apparatus 10 of the present exemplary embodiment includes the image forming unit 12 that forms a toner image on the sheet member P, the fixing unit 34 that fixes the toner image formed on the sheet member P, and the above-described medium discharge system, and the actuator type sensor 62 is disposed downstream of the fixing unit 34 in the transport direction of the sheet member P.

According to the configuration, it is possible to provide the image forming apparatus in which the accuracy of sorting is improved as compared with the configuration in which the actuator type sensor 62 outputs the OFF signal by eliminating the displacement of the sheet member P.

In addition, in the image forming apparatus 10 of the present exemplary embodiment, the drive unit starts to operate after the trailing end of the sheet member P on which the toner image is fixed passes through the fixing unit 34 and before the actuator type sensor 62 outputs the OFF signal.

According to the configuration, the space between the fixing unit 34 and the discharge roll pair 26 is compact as compared with a configuration in which the operation of the shaft 27 is started after the actuator type sensor 62 outputs the OFF signal.

### Modification Example

Although the specific exemplary embodiments of the present disclosure are described in detail, the exemplary embodiment of the present disclosure is not limited to such exemplary embodiments, and it is apparent to persons skilled in the art that various other exemplary embodiments can be taken within the scope of the present disclosure.

The image forming unit 12 is not limited to an electrophotographic type, but may be an inkjet type. In addition, the image forming unit 12 is not limited to the color type even though the image forming unit 12 is the electrophotographic type, but may be a monochrome method.

In the medium discharge system of the present exemplary embodiment, the CPU 72A obtains the length information from the registration sensor 28, but the present exemplary embodiment is not limited thereto. For example, the CPU 72A may acquire length information from the job data.

In addition, in the image forming apparatus 10 of the present exemplary embodiment, the drive unit starts to operate before the actuator type sensor 62 outputs the OFF signal, but the present exemplary embodiment is not limited thereto.

### Supplementary Note

(((1)))

A medium discharge system comprising:
a sensor that outputs a medium-present signal in a case of being displaced by a medium to be transported and outputs a medium-absent signal in a case where the displacement is eliminated;
a discharge roll pair that is disposed downstream of the sensor in a transport direction of the medium, sandwiches the medium, and discharges the medium to a discharge unit;
a moving member that moves the discharge roll pair in a width direction, which is a direction intersecting the transport direction of the medium; and
a processor,
wherein the processor is configured to:
   control an operating period of the moving member based on a time point at which the sensor starts to output the medium-present signal and length information of the medium.
      (((2)))

The medium discharge system according to (((1))), further comprising:
a measurement unit that is disposed upstream of the sensor in the transport direction of the medium and measures a length of the medium in the transport direction,
wherein the processor is configured to:
   obtain the length information from the measurement unit.
      (((3)))

An image forming apparatus comprising:
a forming unit that forms an image on the medium;
a fixing unit that fixes the image formed on the medium; and
the medium discharge system according to (((1))) or (((2))),
wherein the sensor is disposed downstream of the fixing unit in the transport direction of the medium.
   (((4)))

The image forming apparatus according to (((3))),
wherein the moving member starts to operate after a trailing end of the medium on which the image is fixed passes through the fixing unit and before the sensor outputs the medium-absent signal.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A medium discharge system comprising:
a sensor that outputs a medium-present signal in a case of being displaced by a medium to be transported and outputs a medium-absent signal in a case where the displacement is eliminated;
a discharge roll pair that is disposed downstream of the sensor in a transport direction of the medium, sandwiches the medium, and discharges the medium to a discharge unit;
a moving member that moves the discharge roll pair in a width direction, which is a direction intersecting the transport direction of the medium; and
a processor,
wherein the processor is configured to:
control an operating period of the moving member based on a time point at which the sensor starts to output the medium-present signal and length information of the medium.

2. The medium discharge system according to claim 1, further comprising:
a measurement unit that is disposed upstream of the sensor in the transport direction of the medium and measures a length of the medium in the transport direction,
wherein the processor is configured to:
obtain the length information from the measurement unit.

3. An image forming apparatus comprising:
a forming unit that forms an image on the medium;
a fixing unit that fixes the image formed on the medium; and
the medium discharge system according to claim 1,
wherein the sensor is disposed downstream of the fixing unit in the transport direction of the medium.

4. An image forming apparatus comprising:
a forming unit that forms an image on the medium;
a fixing unit that fixes the image formed on the medium; and
the medium discharge system according to claim 2,
wherein the sensor is disposed downstream of the fixing unit in the transport direction of the medium.

5. The image forming apparatus according to claim 3,
wherein the moving member starts to operate after a trailing end of the medium on which the image is fixed passes through the fixing unit and before the sensor outputs the medium-absent signal.

6. The image forming apparatus according to claim 4,
wherein the moving member starts to operate after a trailing end of the medium on which the image is fixed passes through the fixing unit and before the sensor outputs the medium-absent signal.

7. A medium discharge system comprising:
a sensor that outputs a medium-present signal in a case of being displaced by a medium to be transported and outputs a medium-absent signal in a case where the displacement is eliminated;
a discharge roll pair that is disposed downstream of the sensor in a transport direction of the medium, sandwiches the medium, and discharges the medium to a discharge unit;
a moving member that moves the discharge roll pair in a width direction, which is a direction intersecting the transport direction of the medium; and
means for controlling an operating period of the moving member based on a time point at which the sensor starts to output the medium-present signal and length information of the medium.
